(19) United States
(12) Patent Application Publication
(10) Pub. No.: US 2024/0113857 A1
(43) Pub. Date: Apr. 4, 2024

(54) ENCRYPTED PROCESSING UNIT EMULATED WITH HOMOMORPHIC ENCRYPTION CIRCUITS

(71) Applicant: Intel Corporation, Santa Clara, CA (US)

(72) Inventor: Bradley Smith, Vancouver, WA (US)

(73) Assignee: Intel Corporation, Santa Clara, CA (US)

(21) Appl. No.: 17/937,258

(22) Filed: Sep. 30, 2022

(51) Int. Cl. H04L 9/00; G06F 21/72

(52) U.S. Cl. CPC H04L 9/008; G06F 21/72

(57) ABSTRACT

An apparatus comprises processing circuitry to implement an encrypted processing unit (EPU) client comprising a secure enclave, an encrypted processing unit (EPU) server comprising an encrypted processing unit (EPU) communicatively coupled to the secure enclave and at least one pseudo-clock generator, and a memory server communicatively coupled to the encrypted processing unit (EPU) client and to the encrypted processing unit (EPU) server, the memory server to manage a homomorphically encrypted memory.

### BACKGROUND

Subject matter described herein relates generally to the field of computer security and more particularly to technologies to implement an encrypted processing unit (EPU) with homomorphic encryption (HE) circuits.

### BRIEF DESCRIPTION OF THE DRAWINGS

The detailed description is described with reference to the accompanying figures.

FIG. 1 is a schematic, block diagram illustration of components of an environment to implement an encrypted processing unit (EPU) with homomorphic encryption circuits in accordance with some examples.

FIG. 2 is a schematic, block diagram illustration of components of apparatus to implement an encrypted processing unit (EPU) with homomorphic encryption circuits in accordance with some examples.

FIG. 3 is a flowchart illustrating operations in a method to implement an encrypted processing unit (EPU) with homomorphic encryption circuits in accordance with some examples.

FIG. 4 is a schematic illustration of a computing architecture which may be adapted to implement an encrypted processing unit (EPU) with homomorphic encryption circuits in accordance with some examples.

### DETAILED DESCRIPTION

Described herein are exemplary systems and methods to implement an encrypted processing unit (EPU) with homomorphic encryption circuits in accordance with some examples. In the following description, numerous specific details are set forth to provide a thorough understanding of various examples. However, it will be understood by those skilled in the art that the various examples may be practiced without the specific details. In other instances, well-known methods, procedures, components, and circuits have not been illustrated or described in detail so as not to obscure the examples.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

An encrypted processing unit (EPU) is a non-observable, encrypted central processing unit (CPU). An encrypted processing unit (EPU) can be utilized securely without any requirements for security of underlying hardware. A program can be loaded and executed without decryption. This program can process data from both encrypted and unencrypted inputs. A small set of outputs is available to the holder of a private encryption key. No entity can observe the interior states of the processor or the contents of its memory. This level of security is not available in any other technology, including secure enclaves. As described herein, As described herein, an encrypted processing unit (EPU) may be constructed upon the foundation of a processor and memory emulated on Homomorphic Encryption (HE) circuits as if they were digital circuits.

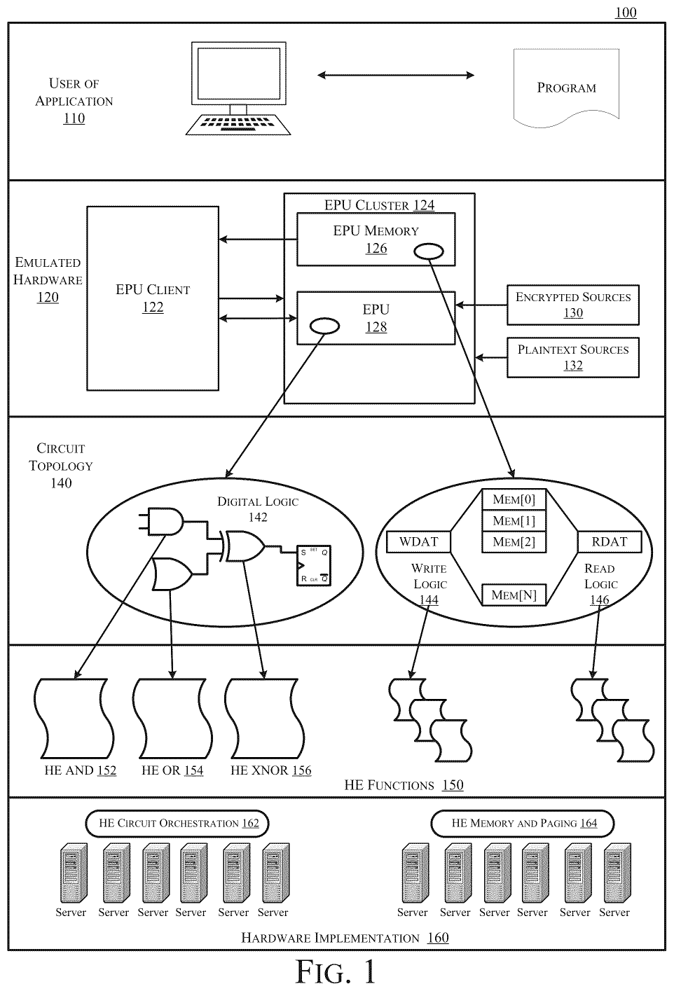

In some examples, using an encrypted processing unit (EPU) rather than purpose-built HE circuit lowers the barrier to entry for developers of Homomorphic Encryption (HE) applications, as the programs can be developed using traditional development tools. These programs can then be ported to the encrypted processing unit (EPU) environment without significant interaction from the developer. Further structural and methodological details are relating to implementing implement an encrypted processing unit (EPU) with homomorphic encryption circuits in accordance with some examples are described below with reference to FIG. 1 through FIG. 3, below

FIG. 1 is a schematic, block diagram illustration of components of an environment 100 to implement an encrypted processing unit (EPU) with homomorphic encryption circuits in accordance with some examples. Referring to FIG. 1, reference numeral 110 represents a user of an application. The user 110 may be entirely ignorant of the applications functionality. The user's application runs on the encrypted processing unit (EPU) and the encrypted processing unit (EPU) memory in a manner similar to how an application may execute on a mainframe computer and be accessed via a VT100 terminal.

The instructions in the application may be encrypted to run on emulated hardware 120. The instructions are data, not the circuitry, so do not comprise any part of the EPU, but are the program that the EPU will execute. The emulated hardware 120 may comprise, for example, a encrypted processing unit (EPU) client 122 and an encrypted processing unit (EPU) cluster 124 which, in turn, comprises an encrypted processing unit (EPU) memory 126 and an encrypted processing unit (EPU) 128. The encrypted processing unit (EPU) cluster 124 receives inputs from encrypted sources 130 and from plaintext sources 132.

A circuit topology 140 may be constructed to represent the functional logic operations implemented by the encrypted processing unit (EPU) memory 126 and the encrypted processing unit (EPU) 128. The operations implemented by the encrypted processing unit (EPU) 128 may be represented as digital logic 142, while the operations implemented by the encrypted processing unit (EPU) memory 126 may be represented as write logic 144 and read logic 146. In some examples a Boolean implementation may be inefficient in the encrypted processing unit (EPU) memory 126. A simple implementation for reading the memory is to perform an equality operation with each of the desired address(es) and every address in memory, resulting in a 0 or 1. These values are then multiplied by every associated data word in the active page. This results in either a 0 or the data contained in the data word. All results are added together to produce a final piece of data.

The Functional logic represented by the circuit topology 140 may be translated to homomorphic encryption (HE) functions 150. For example, digital logic 142 may be translated into homomorphic encryption (HE) logic operators such as homomorphic encryption (HE) AND operators 152, homomorphic encryption (HE) OR operators 154 and homomorphic encryption (HE) XNOR operators 156. An implicit order of operations must be observed when executing homomorphic encryption (HE) operators, and loops are not permitted.

The homomorphic encryption (HE) operators may then be instantiated in a hardware implementation 160, which may be implemented on one or more servers. In a hardware instantiation the functions may be represented as homomorphic encryption (HE) circuit orchestration 162 and homomorphic encryption (HE) memory and paging operations 164.

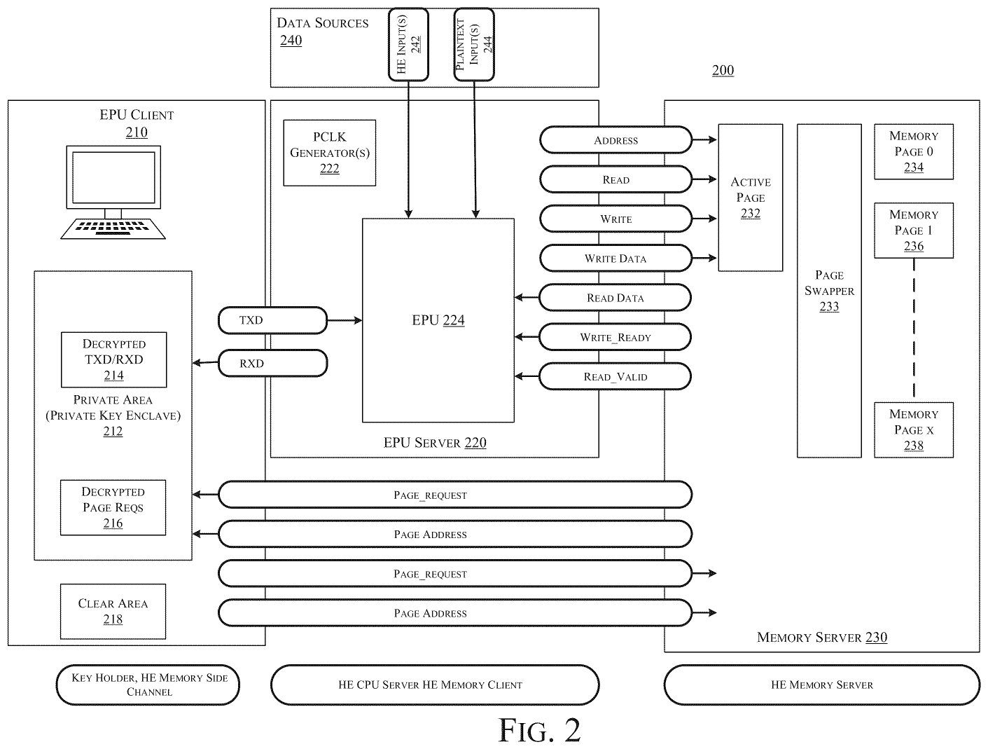

FIG. 2 is a schematic, block diagram illustration of components of apparatus to implement an encrypted processing unit (EPU) emulated with homomorphic encryption circuits in accordance with some examples. Referring to FIG. 2, an encrypted processing unit (EPU) 200 comprises an encrypted processing unit (EPU) client 210, an encrypted processing unit (EPU) server 220, and an encrypted processing unit (EPU) memory server 230.

In some examples the encrypted processing unit (EPU) client 210 comprises a secure enclave 212 that may comprise one or more private encryption keys for homomorphic encryption. The secure enclave 212 may maintains a decrypted transmit data (TXD) and receive data (RXD) interface 214 with an external processing device, e.g., the encrypted processing unit (EPU) server 220, whereby the encrypted processing unit (EPU) client 210 and the encrypted processing unit (EPU) server client 210 can exchange transmit data (TXD) and receive data (RXD) with the encrypted processing unit (EPU) server 220. The encrypted processing unit (EPU) client 210 further maintains one or more decrypted page requests 216 received from the memory server 230 and a clear area 218.

In some examples the encrypted processing unit (EPU) server 220 comprises an encrypted processing unit (EPU) 224 communicatively coupled to the secure enclave and at least one pseudo-clock generator 222. The encrypted processing unit (EPU) 224 in the encrypted processing unit (EPU) server 220 is communicatively coupled to at least one external data source 240 that may comprise homomorphically encrypted inputs 242 and plaintext inputs 244.

In some examples the encrypted processing unit (EPU) server 220 comprises multiple pseudo-clocks which operate at different periodicities of execution and, upon an active pseudo-clock event, the encrypted processing unit (EPU) server 220 evaluates all combinational logic in the encrypted processing unit (EPU) server 220 and updates all state elements in the encrypted processing unit (EPU) server 220. For example, if there are two psuedo-clock domains, domain A and domain B of the same periodicity, they would be evaluated as ABABABABABABAB. If B is half the periodicity of A, then they would be evaluated as AABAABAABAABAABAAB. If the periodicity of A is 3/2 times the periodicity of B, they would be evaluated as AABABAABAB. The periodicity of A and B may be any integer ratio Pa/Pb. These ratios determine the periodic evaluation of each clock domain with relation to the other. In some examples the pseudo-clocks are evaluated in a fixed order according to clock periodicity.

In some examples the encrypted processing unit (EPU) memory server 230 communicatively coupled to the encrypted processing unit (EPU) client 210 and to the encrypted processing unit (EPU) server 220 and servers to manage a homomorphically encrypted memory. The memory server 230 comprises at least one active memory page 232 and plurality of inactive memory pages 234, 236, 238, and a memory swapper 233 to swap memory pages between active memory and inactive memory. In some examples the active memory page 232 and the inactive memory pages 234, 236, 238 are homomorphically encrypted.

Periodically, the encrypted processing unit (EPU) memory server 230 transmits the status of the homomorphic encryption (HE) memory as an encrypted datum to the encrypted processing unit (EPU) client 210 to be decoded in the secure enclave 212. If there is an active page request, the encrypted processing unit (EPU) client 210 responds with a non-homomorphic encryption (HE) page swap command. If there is no request, the encrypted processing unit (EPU) client 210 responds with a non-homomorphic encryption (HE) no operation (NOP) instruction. Every request must be acknowledged before the system can continue.

In the event of a page swap command, the encrypted processing unit (EPU) memory server 230 performs the swap and provides the homomorphic encryption (HE) memory circuit with a “swap complete” input (can be plaintext or cipher text). IF the memory server receives a no operation (NOP) instruction, then it informs the homomorphic encryption (HE) memory with a no operation (NOP) instruction input. In some examples this long handshake must be performed periodically to continue execution. If the homomorphic encryption (HE) circuit has run out of page data, it will still evaluate on every pseudo clock until the “Page Swap Complete” input is received. This input allows the memory circuit to signal the encrypted processing unit (EPU) circuit that the requested. In some examples, the memory page request handshake is done at a lower periodicity from the internal pseudo clocks to minimize the long path and evaluation.

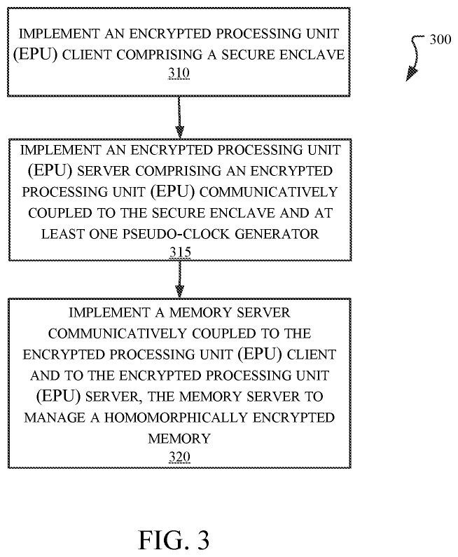

FIG. 3 is a flowchart illustrating operations in a method to implement an encrypted processing unit (EPU) with homomorphic encryption circuits in accordance with some examples. Referring to FIG. 3, at operation 310 an encrypted processing unit (EPU) client comprising a secure enclave is implemented. At operation 315 an encrypted processing unit (EPU) server comprising an encrypted processing unit (EPU) communicatively coupled to the secure enclave and at least one pseudo-clock generator is implemented. At operation 320 a memory server communicatively coupled to the encrypted processing unit (EPU) client and to the encrypted processing unit (EPU) server, the memory server to manage a homomorphically encrypted memory is implemented.

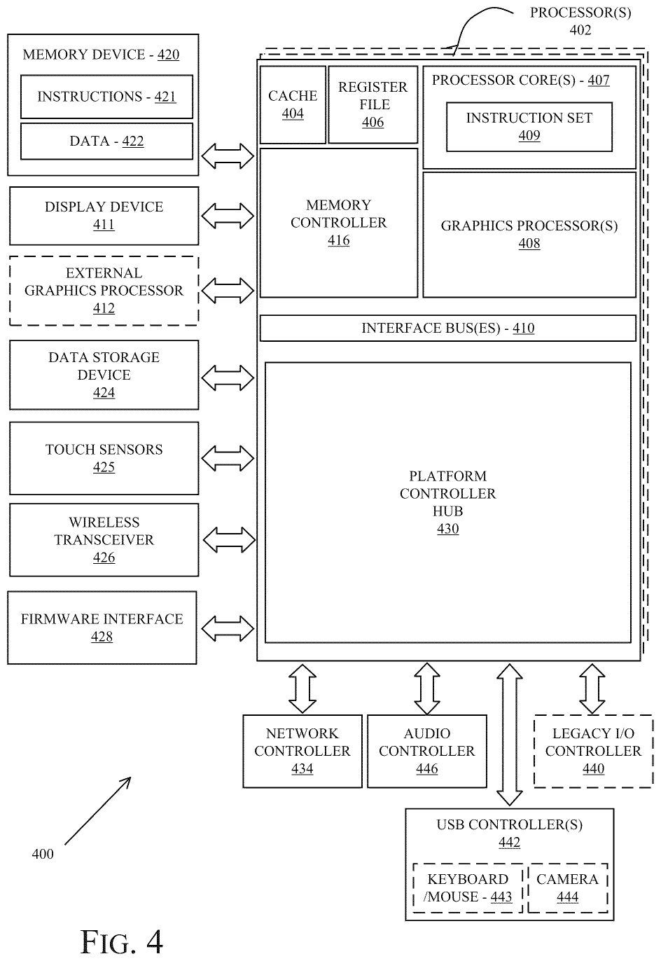

FIG. 4 illustrates an embodiment of an exemplary computing architecture that may be suitable for implementing various embodiments as previously described. In various embodiments, the computing architecture 400 may comprise or be implemented as part of an electronic device. In some embodiments, the computing architecture 400 may be representative, for example of a computer system that implements one or more components of the operating environments described above. In some embodiments, computing architecture 400 may be representative of one or more portions or components of a digital signature signing system that implement one or more techniques described herein. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 400. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 400 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 400.

As shown in FIG. 4, the computing architecture 400 includes one or more processors 402 and one or more graphics processors 408, and may be a single processor desktop system, a multiprocessor workstation system, or a server system having a large number of processors 402 or processor cores 407. In on embodiment, the system 400 is a processing platform incorporated within a system-on-a-chip (SoC or SOC) integrated circuit for use in mobile, handheld, or embedded devices.

An embodiment of system 400 can include, or be incorporated within, a server-based gaming platform, a game console, including a game and media console, a mobile gaming console, a handheld game console, or an online game console. In some embodiments system 400 is a mobile phone, smart phone, tablet computing device or mobile Internet device. Data processing system 400 can also include, couple with, or be integrated within a wearable device, such as a smart watch wearable device, smart eyewear device, augmented reality device, or virtual reality device. In some embodiments, data processing system 400 is a television or set top box device having one or more processors 402 and a graphical interface generated by one or more graphics processors 408.

In some embodiments, the one or more processors 402 each include one or more processor cores 407 to process instructions which, when executed, perform operations for system and user software. In some embodiments, each of the one or more processor cores 407 is configured to process a specific instruction set 409. In some embodiments, instruction set 409 may facilitate Complex Instruction Set Computing (CISC), Reduced Instruction Set Computing (RISC), or computing via a Very Long Instruction Word (VLIW). Multiple processor cores 407 may each process a different instruction set 409, which may include instructions to facilitate the emulation of other instruction sets. Processor core 407 may also include other processing devices, such a Digital Signal Processor (DSP).

In some embodiments, the processor 402 includes cache memory 404. Depending on the architecture, the processor 402 can have a single internal cache or multiple levels of internal cache. In some embodiments, the cache memory is shared among various components of the processor 402. In some embodiments, the processor 402 also uses an external cache (e.g., a Level-3 (L3) cache or Last Level Cache (LLC)) (not shown), which may be shared among processor cores 407 using known cache coherency techniques. A register file 406 is additionally included in processor 402 which may include different types of registers for storing different types of data (e.g., integer registers, floating point registers, status registers, and an instruction pointer register). Some registers may be general-purpose registers, while other registers may be specific to the design of the processor 402.

In some embodiments, one or more processor(s) 402 are coupled with one or more interface bus(es) 410 to transmit communication signals such as address, data, or control signals between processor 402 and other components in the system. The interface bus 410, in one embodiment, can be a processor bus, such as a version of the Direct Media Interface (DMI) bus. However, processor busses are not limited to the DMI bus, and may include one or more Peripheral Component Interconnect buses (e.g., PCI, PCI Express), memory busses, or other types of interface busses. In one embodiment the processor(s) 402 include an integrated memory controller 416 and a platform controller hub 430. The memory controller 416 facilitates communication between a memory device and other components of the system 400, while the platform controller hub (PCH) 430 provides connections to I/O devices via a local I/O bus.

Memory device 420 can be a dynamic random-access memory (DRAM) device, a static random-access memory (SRAM) device, flash memory device, phase-change memory device, or some other memory device having suitable performance to serve as process memory. In one embodiment the memory device 420 can operate as system memory for the system 400, to store data 422 and instructions 421 for use when the one or more processors 402 executes an application or process. Memory controller hub 416 also couples with an optional external graphics processor 412, which may communicate with the one or more graphics processors 408 in processors 402 to perform graphics and media operations. In some embodiments a display device 411 can connect to the processor(s) 402. The display device 411 can be one or more of an internal display device, as in a mobile electronic device or a laptop device or an external display device attached via a display interface (e.g., DisplayPort, etc.). In one embodiment the display device 411 can be a head mounted display (HMD) such as a stereoscopic display device for use in virtual reality (VR) applications or augmented reality (AR) applications.

In some embodiments the platform controller hub 430 enables peripherals to connect to memory device 420 and processor 402 via a high-speed I/O bus. The I/O peripherals include, but are not limited to, an audio controller 446, a network controller 434, a firmware interface 428, a wireless transceiver 426, touch sensors 425, a data storage device 424 (e.g., hard disk drive, flash memory, etc.). The data storage device 424 can connect via a storage interface (e.g., SATA) or via a peripheral bus, such as a Peripheral Component Interconnect bus (e.g., PCI, PCI Express). The touch sensors 425 can include touch screen sensors, pressure sensors, or fingerprint sensors. The wireless transceiver 426 can be a Wi-Fi transceiver, a Bluetooth transceiver, or a mobile network transceiver such as a 3G, 4G, or Long Term Evolution (LTE) transceiver. The firmware interface 428 enables communication with system firmware, and can be, for example, a unified extensible firmware interface (UEFI). The network controller 434 can enable a network connection to a wired network. In some embodiments, a high-performance network controller (not shown) couples with the interface bus 410. The audio controller 446, in one embodiment, is a multi-channel high definition audio controller. In one embodiment the system 400 includes an optional legacy I/O controller 440 for coupling legacy (e.g., Personal System 2 (PS/2)) devices to the system. The platform controller hub 430 can also connect to one or more Universal Serial Bus (USB) controllers 442 connect input devices, such as keyboard and mouse 443 combinations, a camera 444, or other USB input devices.

The following pertains to further examples.

Example 1 is an apparatus, comprising processing circuitry processing circuitry to implement an encrypted processing unit (EPU) client comprising a secure enclave; an encrypted processing unit (EPU) server comprising an encrypted processing unit (EPU) communicatively coupled to the secure enclave and at least one pseudo-clock generator; and a memory server communicatively coupled to the encrypted processing unit (EPU) client and to the encrypted processing unit (EPU) server, the memory server to manage a homomorphically encrypted memory.

In Example 2, the subject matter of Example 1 can optionally include an arrangement wherein the secure enclave in the encrypted processing unit (EPU) client maintains a decrypted transmit data (TXD) and receive data (RXD) interface with an external processing device.

In Example 3, the subject matter of any one of Examples 1-2 can optionally include an arrangement wherein the encrypted processing unit (EPU) exchanges transmit data (TXD) and receive data (RXD) with the decrypted transmit data (TXD) and receive data (RXD) interface.

In Example 4, the subject matter of any one of Examples 1-3 can optionally include an arrangement the secure enclave in the encrypted processing unit (EPU) client maintains a decrypted page requests file communicatively coupled to a clear area.

In Example 5, the subject matter of any one of Examples 1-4 can optionally include an arrangement the encrypted processing unit (EPU) memory server transmits a status of a homomorphic encryption (HE) memory as an encrypted datum to the encrypted processing unit (EPU) client.

In Example 6, the subject matter of any one of Examples 1-5 can optionally an arrangement the encrypted processing unit (EPU) client decodes the status in a secure enclave.

In Example 7, the subject matter of any one of Examples 1-6 can optionally include an arrangement wherein the memory server comprises a page swapper which, in response a page request from the encrypted processing unit (EPU) client, creates an active memory page from a memory page identified by the page address.

In Example 8, the subject matter of any one of Examples 1-7 can optionally include an arrangement wherein the active memory page is homomorphically encrypted.

In Example 9, the subject matter of any one of Examples 1-8 can optionally include an arrangement wherein the encrypted processing unit (EPU) in the encrypted processing unit (EPU) server initiates homomorphically encrypted memory access transactions to the active memory page.

In Example 10, the subject matter of any one of Examples 1-9 can optionally include an arrangement wherein the memory server periodically copies a set of outputs from a memory circuit to the encrypted processing unit (EPU) input

In Example 11, the subject matter of any one of Examples 1-10 can optionally include an arrangement wherein at least one output in the set of outputs indicates that data is ready.

In Example 12, the subject matter of any one of Examples 1-11 can optionally include an arrangement wherein the secure enclave comprises at least one private encryption key for homomorphic encryption.

In Example 13, the subject matter of any one of Examples 1-12 can optionally include an arrangement wherein the encrypted processing unit (EPU) in the encrypted processing unit (EPU) server is communicatively coupled to at least one external data source.

In Example 14, the subject matter of any one of Examples 1-13 can optionally include an arrangement wherein the encrypted processing unit (EPU) server comprises multiple pseudo-clocks which operate at different periodicities.

In Example 15, the subject matter of any one of Examples 1-14 can optionally include an arrangement wherein, upon an active pseudo-clock event, the encrypted processing unit (EPU) server evaluates all combinational logic in the encrypted processing unit (EPU) server and updates all state elements in the encrypted processing unit (EPU) server

In Example 16, the subject matter of any one of Examples 1-15 can optionally include an arrangement pseudo-clocks are evaluated in a fixed order according to a clock periodicity.

In Example 17, the subject matter of any one of Examples 1-16 can optionally include an arrangement the memory comprises a plurality of state elements; and the memory server evaluates each of the plurality of state elements in every cycle of a pseudo-clock.

The above Detailed Description includes references to the accompanying drawings, which form a part of the Detailed Description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In addition “a set of” includes one or more elements. In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” etc. are used merely as labels, and are not intended to suggest a numerical order for their objects.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus, comprising:
processing circuitry to implement:
an encrypted processing unit (EPU) client comprising a secure enclave;
an encrypted processing unit (EPU) server comprising an encrypted processing unit (EPU) communicatively coupled to the secure enclave and at least one pseudo-clock generator; and
a memory server communicatively coupled to the encrypted processing unit (EPU) client and to the encrypted processing unit (EPU) server, the memory server to manage a homomorphically encrypted memory.

2. The apparatus of claim 1, wherein the secure enclave in the encrypted processing unit (EPU) client maintains a decrypted transmit data (TXD) and receive data (RXD) interface with an external processing device.

3. The apparatus of claim 1, wherein:
the encrypted processing unit (EPU) exchanges transmit data (TXD) and receive data (RXD) with the decrypted transmit data (TXD) and receive data (RXD) interface.

4. The apparatus of claim 1, wherein:
the secure enclave in the encrypted processing unit (EPU) client maintains a decrypted page requests file communicatively coupled to a clear area.

5. The apparatus of claim 4, wherein:
the encrypted processing unit (EPU) memory server transmits a status of a homomorphic encryption (HE) memory as an encrypted datum to the encrypted processing unit (EPU) client.

6. The apparatus of claim 5, wherein:
encrypted processing unit (EPU) client decodes the status in a secure enclave.

7. The apparatus of claim 5, wherein:
the memory server comprises a page swapper which, in response a page request from the encrypted processing unit (EPU) client, creates an active memory page from a memory page identified by the page address.

8. The apparatus of claim 6, wherein:
the active memory page is homomorphically encrypted.

9. The apparatus of claim 6, wherein:
the encrypted processing unit (EPU) in the encrypted processing unit (EPU) server initiates homomorphically encrypted memory access transactions to the active memory page.

10. The apparatus of claim 8, wherein:
the memory server periodically copies a set of outputs from a memory circuit to the encrypted processing unit (EPU) input.

11. The apparatus of claim 10, wherein:
at least one output in the set of outputs indicates that data is ready.

12. The apparatus of claim 1, wherein:
the secure enclave comprises at least one private encryption key for homomorphic encryption.

13. The apparatus of claim 1, wherein:
the encrypted processing unit (EPU) in the encrypted processing unit (EPU) server is communicatively coupled to at least one external data source.

14. The apparatus of claim 1, wherein:
the encrypted processing unit (EPU) server comprises multiple pseudo-clocks which operate at different periodicities.

15. The apparatus of claim 14, wherein, upon an active pseudo-clock event, the encrypted processing unit (EPU) server evaluates all combinational logic in the encrypted processing unit (EPU) server and updates all state elements in the encrypted processing unit (EPU) server.

16. The apparatus of claim 14, wherein:
pseudo-clocks are evaluated in a fixed order according to a clock periodicity.

17. The apparatus of claim 14, wherein:
the memory comprises a plurality of state elements; and
the memory server evaluates each of the plurality of state elements in every cycle of a pseudo-clock.

18. A computer-based method, comprising:
processing circuitry to implement:
implementing an encrypted processing unit (EPU) client comprising a secure enclave;
implementing an encrypted processing unit (EPU) server comprising an encrypted processing unit (EPU) communicatively coupled to the secure enclave and at least one pseudo-clock generator; and
implementing a memory server communicatively coupled to the encrypted processing unit (EPU) client and to the encrypted processing unit (EPU) server, the memory server to manage a homomorphically encrypted memory.

19. The method of claim 18, wherein the secure enclave in the encrypted processing unit (EPU) client maintains a decrypted transmit data (TXD) and receive data (RXD) interface with an external processing device.

20. A non-transitory computer-readable medium comprising instructions which, when executed by a processor, configure the processor to:
implement an encrypted processing unit (EPU) client comprising a secure enclave;
implement an encrypted processing unit (EPU) server comprising an encrypted processing unit (EPU) communicatively coupled to the secure enclave and at least one pseudo-clock generator; and
implement a memory server communicatively coupled to the encrypted processing unit (EPU) client and to the encrypted processing unit (EPU) server, the memory server to manage a homomorphically encrypted memory.

21. The non-transitory computer-readable medium of claim 20, wherein the secure enclave in the encrypted processing unit (EPU) client maintains a decrypted transmit data (TXD) and receive data (RXD) interface with an external processing device.
